(19) United States
(12) Patent Application Publication
(10) Pub. No.: US 2018/0010541 A1
(43) Pub. Date: Jan. 11, 2018

(54) Leakage Detection in Engine Air Systems

(71) Applicant: Caterpillar Inc., Peoria, IL (US)

(72) Inventors: Qiang Chen, Dunlap, IL (US); Nathan Stephen Pauli, Peoria, IL (US); Evan E. Jacobson, Edwards, IL (US); Yanchai Zhang, Dunlap, IL (US); Bo Xie, Peoria, IL (US)

(73) Assignee: Caterpillar Inc., Peoria, IL (US)

(21) Appl. No.: 15/207,114

(22) Filed: Jul. 11, 2016

(51) Int. Cl. F02D 41/22; F02M 35/10; F02B 37/007

(52) U.S. Cl. CPC F02D 41/22; F02B 37/007; F02M 35/1038

(57) ABSTRACT

A leak detection system for an engine air system is provided. The leak detection system may include a plurality of pressure sensors configured to retrieve pressure data from the engine air system, a plurality of temperature sensors configured to retrieve temperature data from the engine air system, and a controller in communication with each of the pressure sensors and the temperature sensors. The controller may be configured to receive the pressure data and the temperature data, compare the pressure data and the temperature data to one or more predefined data trends, and identify a leak within the engine air system based on the comparison.

### TECHNICAL FIELD

The present disclosure relates generally to internal combustion engines, and more particularly, to systems and methods for detecting leaks within the air system of internal combustion engines.

### BACKGROUND

Internal combustion engines, such as diesel engines, gasoline engines, natural gas engines, and the like, may be used to power various different types of machines, such as on-highway trucks or vehicles, off-highway machines, earth-moving equipment, generators, aerospace applications, pumps, stationary equipment such as power plants, and the like. In general terms, internal combustion engines are supplied with a mixture of air and fuel, which is ignited at specific timing intervals in order to generate mechanical energy, such as rotational output torque, and ultimately used to drive or operate the associated machine. Among other ongoing efforts to improve the efficiency and reliability of the engine, and thereby the overall productivity of the machine, one area of improvement concerns the integrity of the network of lines, tubes, pipes, manifolds, and the like, which supply air and fuel into the engine as well as eject exhaust gases out of the engine.

Dealing with air leaks within the engine air system still remains to be a major source of concern in conventional engines. In particular, air leaks can form within the engine air system and gradually get worse over time, all without detection. Even if a leak is detected, locating the leak is yet another significant challenge, especially in machines where access to the engine is extremely limited. All too often, the machine must be decommissioned and dismantled just to locate and fix the air leak, which can consume significant hours, days, weeks or even months of downtime to completely resolve. The difficulties and downtimes are further compounded in turbocharged applications with more complex engine air systems which tend to be more prone to air leaks and require even more downtime to locate and fix such air leaks.

While some conventional techniques for detecting air leaks in engine air systems may exist, there is still room for improvement. As disclosed in U.S. Pat. No. 8,447,456 (“Wang”), one such method detects air leaks based on measured air flow rates, pressures and calculated thresholds. However, while Wang may be able to detect whether an air leak exists, Wang is unable to identify the location of the air leak. As discussed above, while detecting air leaks is important, most of the difficulties and downtime are related to the process of locating the air leak. Furthermore, while primitive standalone techniques for locating air leaks may be well known, such as specialized sprays and vacuum systems, these techniques are not integrated into the normal operations of the engine and would still require substantial downtime just to access the engine and/or engine air system in certain machine configurations.

In view of the foregoing disadvantages associated with conventional engine air systems, a need exists for a solution which, not only detects, but also locates air leaks without requiring significant costs to implement, and without interfering with normal operations. Moreover, there is a need for air leakage detection systems and methods which are capable of reducing overall downtimes associated with air leaks and improves overall efficiency and reliability of the engine. The present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, a leak detection system for an engine air system is provided. The leak detection system may include a plurality of pressure sensors configured to retrieve pressure data from the engine air system, a plurality of temperature sensors configured to retrieve temperature data from the engine air system, and a controller in communication with each of the pressure sensors and the temperature sensors. The controller may be configured to receive the pressure data and the temperature data, compare the pressure data and the temperature data to one or more predefined data trends, and identify a leak within the engine air system based on the comparison.

In another aspect of the present disclosure, an air system for an engine is provided. The air system may include an intake manifold having a first pressure sensor and a first temperature sensor, an exhaust manifold having a second temperature sensor, a turbine coupled to the exhaust manifold, a compressor coupled to the intake manifold and having a second pressure sensor, and a controller coupled to each of the first pressure sensor, the second pressure sensor, the first temperature sensor and the second temperature sensor. The controller may be configured to receive pressure data and temperature data, compare the pressure data and the temperature data to one or more predefined data trends, and identify an air leak based on the comparison.

In yet another aspect of the present disclosure, a method of detecting leakage in an engine air system is provided. The method may include receiving pressure data including compressor outlet pressure data and intake manifold pressure data, and temperature data including exhaust manifold temperature data and intake manifold temperature data, comparing the pressure data and the temperature data to one or more predefined data trends, and identifying a leak within the engine air system based on the comparison.

These and other aspects and features will be more readily understood when reading the following detailed description in conjunction with the accompanying drawings.

### BRIEF DESCRIPTION OF THE DRAWINGS

FIG. 1 is a partial diagrammatic view of a machine having an engine and an engine air system;

FIG. 2 is a diagrammatic view of one exemplary embodiment of a leak detection system for an engine air system constructed in accordance with the teachings of the present disclosure;

FIG. 3 is a diagrammatic view of one exemplary controller that may be used with a leak detection system of the present disclosure;

FIG. 4 is a graphical view of one exemplary data trend that may be preprogrammed and indicative of a leak in the compressor outlet;

FIG. 5 is a graphical view of another exemplary data trend that may be preprogrammed and indicative of a leak in the turbine inlet;

FIG. 6 is a graphical view of yet another exemplary data trend that may be preprogrammed and indicative of a leak in the intake manifold; and

FIG. 7 is a flow diagram of one exemplary algorithm or method of detecting leakage in an engine air system.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

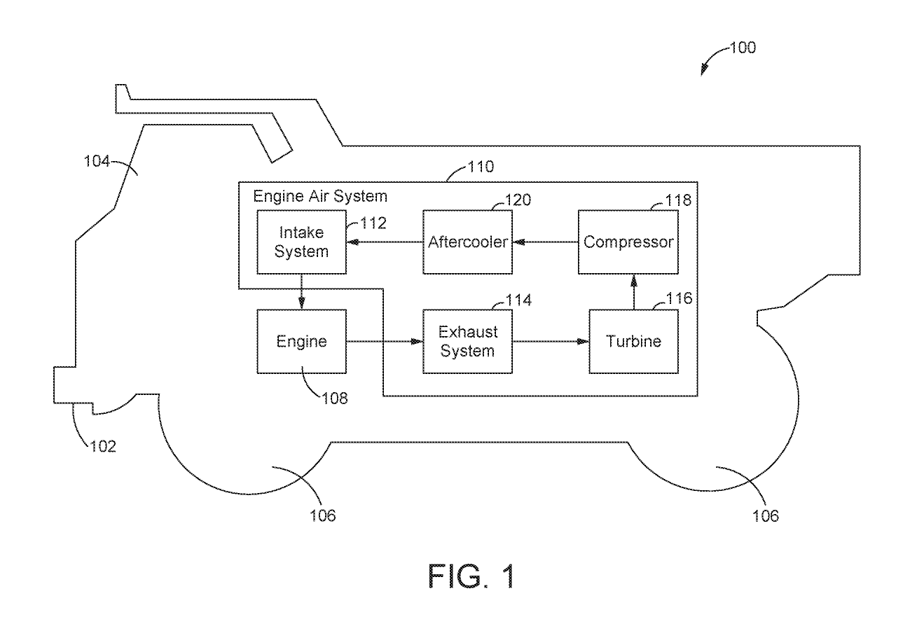

Referring to FIG. 1, one exemplary machine 100 is provided. As shown, the machine 100 may include a frame 102, an operator cab 104, one or more traction devices 106, an engine 108 and an engine air system 110. Although the machine 100 is shown as a truck, machine 100 could be any type of mobile or stationary machine having an exhaust producing engine. For example, the machine 100 may encompass on-highway trucks or vehicles, off-highway machines, earth-moving equipment, generators, aerospace applications, pumps, stationary equipment such as power plants, and the like. In mobile applications, the traction devices 106 may include wheels as shown in FIG. 1, or alternatively, tracks, belts, or any other suitable mechanism capable of causing movement of the machine 100. The engine 108 may include any suitable internal combustion engine that uses air and fuel mixtures to generate mechanical power, such as rotational torque output, and discharges exhaust gases. For example, the engine 108 may include a diesel engine, a gasoline engine, a natural gas engine, or any other suitable internal combustion engine.

Still referring to FIG. 1, one exemplary embodiment of the engine air system 110 is schematically shown. In general, the engine air system 110 may be coupled to and/or integrated into the engine 108 and include an intake system 112, an exhaust system 114, a turbine 116, a compressor 118 and an aftercooler 120. As is well recognized in the art, the intake system 112 supplies air to be mixed with fuel and used for combustion to the engine 108, while the exhaust system 114 removes pollutants and expels exhaust gases produced by the combustion. Before entirely exiting the engine air system 110, the exhaust gases may be received by the turbine 116 and used to compress ambient air received through the compressor 118. As is understood in the art, the exhaust gases may spin an impeller within the turbine 116, which in turn spins an impeller within the compressor 118 to compress air received at the compressor 118. The compressed air may then be fed into the aftercooler 120, such as an air-to-air aftercooler, which cools the compressed air before reaching the intake system 112 and the engine 108.

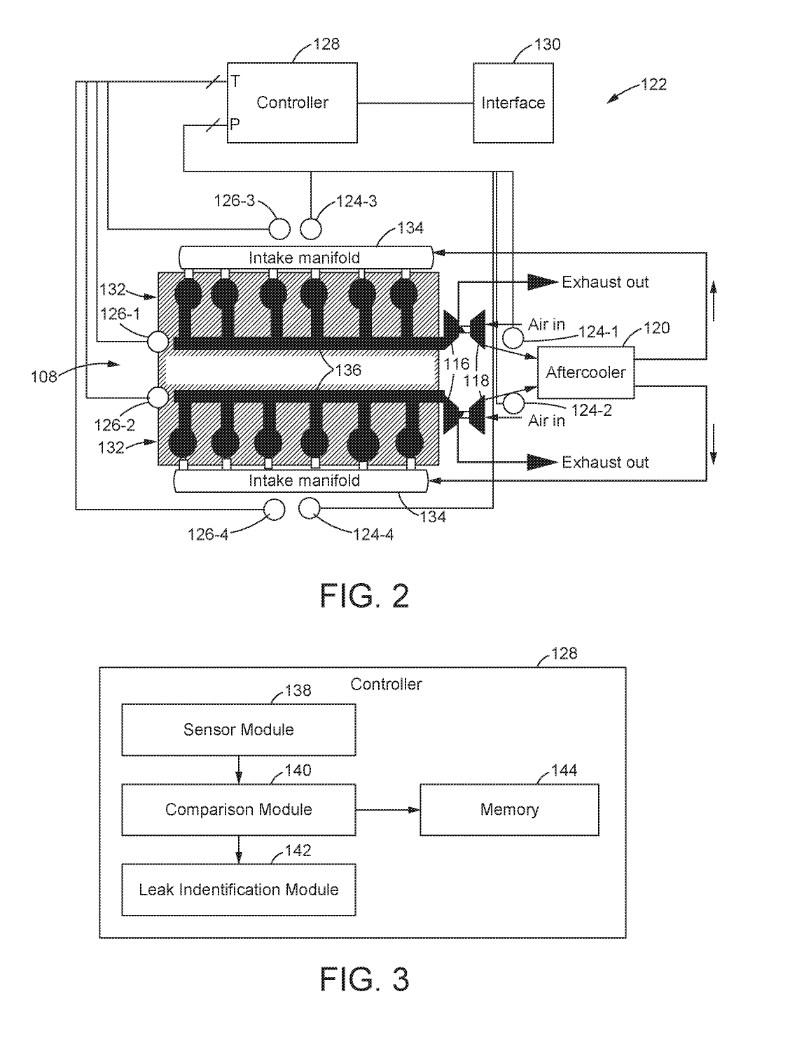

Turning to FIG. 2, one exemplary embodiment of a leak detection system 122 as implemented into an engine air system 110 is diagrammatically provided. As shown, the leak detection system 122 may include a plurality of pressure sensors 124 positioned and configured to retrieve pressure data from the engine air system 110, a plurality of temperature sensors 126 positioned and configured to retrieve temperature data from the engine air system 110, a controller 128 in communication with each of the pressure sensors 124 and the temperature sensors 126, and an interface 130 in communication with the controller 128. In general, the controller 128 may be configured to receive the pressure data provided by the pressure sensors 124 and the temperature data provided by the temperature sensors 126, compare the pressure data and the temperature data to one or more predefined references, and identify the presence and location of a leak within the engine air system 110 based on the comparison. The interface 130 may include any combination of input and/or output devices capable of communicating information to an operator.

In the particular embodiment shown in FIG. 2, the engine 108 includes two cylinder banks 132, and thus, the engine air system 110 correspondingly includes two sets of intake manifolds 134, exhaust manifolds 136, turbines 116, and compressors 118, one for each cylinder bank 132. The leak detection system 122 may accordingly include pressure sensors 124 and temperature sensors 126 for each cylinder bank 132. For example, a first pressure sensor 124-1 and a second pressure sensor 124-2 may be positioned at the outlets of the compressors 118 and configured to retrieve compressor outlet pressure data, while a third pressure sensor 124-3 and a fourth pressure sensor 124-4 may be positioned at the intake manifolds 134 and configured to retrieve intake manifold pressure data from each cylinder bank 132. The leak detection system 122 may also include a first temperature sensor 126-1 and a second temperature sensor 126-2 positioned at respective exhaust manifolds 136 and configured to retrieve exhaust manifold temperature data. A third temperature sensor 126-3 and a fourth temperature sensor 126-4 may also be positioned at the intake manifold 134 and configured to retrieve intake manifold temperature data.

Although the embodiment in FIG. 2 depicts one possible arrangement or configuration of the leak detection system 122, it will be understood that other variations or permutations will be readily apparent to those of ordinary skill in the art. Moreover, the leak detection system 122 may be configured for use with other engine types or configurations different than shown in FIG. 2. For example, the leak detection system 122 may be adapted for use with engine configurations employing fewer than or more than two cylinder banks 132, and/or other engine sizes. Additionally, one or more of the pressure sensors 124 and the temperature sensors 126 may be preexisting or newly integrated. Furthermore, any one or more of the pressure sensors 124 and the temperature sensors 126 may be positioned in other locations of the engine air system 110 or arranged in other configurations to provide comparable results. Any one or more pressure sensors 124 and temperature sensors 126 may also be omitted or added to the leak detection system 122 based on the desired application.

Referring now to FIG. 3, one exemplary embodiment of a controller 128 that may be used with the leak detection system 122 is diagrammatically provided. As shown in FIG. 3, and as generally described above with respect to FIG. 2, the controller 128 may be implemented using one or more of a processor, a microprocessor, a microcontroller, an electronic control module (ECM), an electronic control unit (ECU), and any other suitable device for communicating with any one or more of the pressure sensors 124, the temperature sensors 126, the interface 130, and the like. The controller 128 may be configured to operate according to predetermined algorithms or sets of logic instructions designed to operate the leak detection system 122, monitor the engine air system 110 for leaks, and identify the location of any detected leaks based on predefined data trends, patterns, lookup tables, maps, mathematical models, or other forms of reference programmed therein. Furthermore, the algorithms or sets of logic instructions may be implemented on controllers 128 that are preexisting within the machine 100 and/or newly implemented and dedicated to operate the leak detection system 122.

As shown in FIG. 3, the controller 128 may be configured to function according to one or more preprogrammed algorithms, which may be generally categorized into, for example, a sensor module 138, a comparison module 140, and a leak identification module 142. The controller 128 may additionally include access to memory 144, such as local on-board memory and/or memory remotely situated from the controller 128, for storing any one or more of the algorithms, pressure sensor data, temperature sensor data, as well as references, such as predefined data trends, patterns, lookup tables, maps, mathematical models, and any other relevant information or logic instructions. It will be understood that the arrangement of grouped code or logic instructions shown in FIG. 3 merely demonstrates one possible way to perform the functions of the leak detection system 122, and that other comparable arrangements are possible and will be apparent to those of ordinary skill in the art. Other embodiments, for instance, may modify, omit, merge and/or add to the modules 138, 140, 142 shown in FIG. 3 and still achieve comparable results.

Still referring to FIG. 3, the sensor module 138 of the controller 128 may initially communicate with each of the pressure sensors 124 and the temperature sensors 126 to monitor the pressure data and the temperature data associated with the engine air system 110 for leaks. More particularly, the sensor module 138 may be configured to receive compressor outlet pressure data and intake manifold pressure data from the pressure sensors 124, and receive exhaust manifold temperature data and intake manifold temperature data from the temperature sensors 126. Alternatively, in other embodiments with different sensor arrangements, the sensor module 138 may be configured to derive compressor outlet pressure data, intake manifold pressure data, exhaust manifold temperature data, intake manifold temperature data, and/or values comparable thereto, using other techniques or calculations.

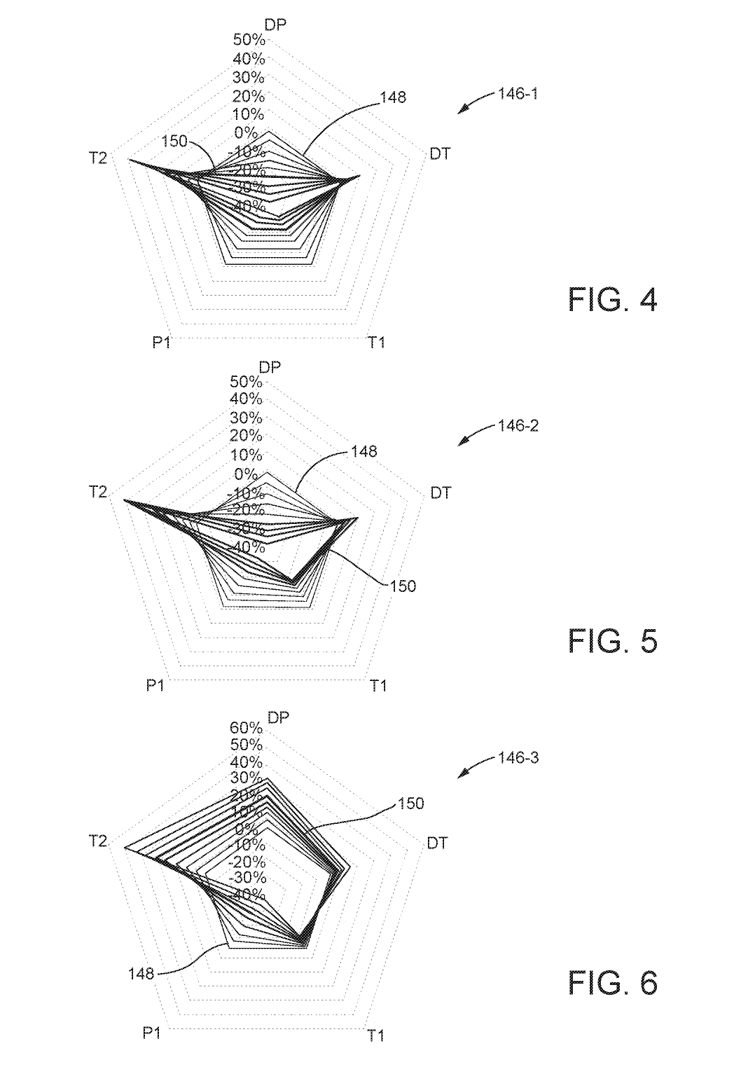

In turn, the comparison module 140 of the controller 128 of FIG. 3 may be configured to compare the pressure data and the temperature data to one or more predefined references. For example, the comparison module 140 may initially look for or establish a steady state in the operation of the engine 108 in order to compare the stream of pressure and temperature data against reference data trends 146 preprogrammed into memory 144, as shown in FIGS. 4-6. For example, the comparison module 140 may refer to a plurality of different data trends 146, each of which represents previously simulated or known pressure-temperature traits of the engine air system 110 in the event of a leak, and each of which represents pressure-temperature traits for a leak occurring at a different location within the engine air system 110. For instance, the first data trend 146-1 of FIG. 4 may be indicative of a leak in the outlet of the compressor 118, the second data trend 146-2 of FIG. 5 may be indicative of a leak in the inlet of the turbine 116, and the third data trend 146-3 of FIG. 6 may be indicative of a leak in the intake manifold 134.

As illustrated in FIGS. 4-6, each of the data trends 146 may simultaneously observe a plurality of engine parameters over time, such as at predefined intervals and/or per iteration of operation, to monitor for significant changes that can be indicative of a leak. In FIGS. 4-6, for instance, the data trends 146 simultaneously monitor the intake manifold pressure data (P1), the intake manifold temperature data (T1), the exhaust manifold temperature data (T2), the difference in the intake manifold temperature data taken between the two cylinder banks 132 (T1.1-T1.2 or DT), and the difference between the compressor outlet pressure data and the intake manifold pressure data (P2-P1 or DP). As shown, each data trend 146 begins with a baseline or default state 148 representative of ideal conditions and no air leaks, which gradually shifts into a flagged state 150 representative of a detected air leak. Notably, the default state 148 in each data trend 146 is identical, while the respective flagged states 150, each indicating different leak locations, differ substantially.

Correspondingly, the comparison module 140 of FIG. 3 may be able to compare streams of pressure data and temperature data received from the engine air system 110 to the different data trends 146 of FIGS. 4-6 to enable the leak identification module 142 to determine not only the existence of an air leak within the engine air system 110, but also the location of the leak within the engine air system 110. For example, if the stream of data mimics or substantially resembles the first data trend 146-1, the leak identification module 142 may be able to confirm that there is a leak in the outlet of the compressor 118. Similarly, if the stream of data substantially resembles the second data trend 146-2 or the third data trend 146-3, the leak identification module 142 may confirm that there is a leak in the inlet of the turbine 116 or in the intake manifold 134, respectively. Furthermore, the comparison module 140 may reiteratively perform any of the comparisons simultaneously, successively or independently of one another.

Although the data trends 146 in FIGS. 4-6 collectively depict one possible scheme for identifying leaks, other embodiments may refer to fewer than or more than three data trends 146 to detect leaks within the engine air system 110. In other modifications, other combinations of measurements and sensor data, and/or other types of trends or patterns in data may be used to detect and identify leaks located in other parts of the engine air system 110. In still further modifications, each data trend 146, or any of the parameters thereof, may be altered to be more or less sensitive to air leaks. Furthermore, leaks within the engine air system 110 may alternatively be detected and located using references other than data trends 146, including, but not limited to, lookup tables, maps, mathematical models, such as models that are completely empirical, completely physics-based, or combinations thereof, and the like. For example, a mathematical model of a neural network may be employed to receive the sensor data and directly output one of a plurality of predefined status indicators which indicate the presence of any leaks within the engine air system 110.

Additionally or optionally, for better reliability, the controller 128 in FIG. 3 may be configured to process only pressure data and temperature data collected under conditions similar to the conditions under which the data trends 146 were formed, such as in terms of engine speed, load, ambient temperature, ambient pressure, and the like. In other modifications, the controller 128 may additionally be configured to generate a notification that is indicative of a leak and/or the location of the leak within the engine air system 110 to be communicated to an operator. The notification may be generated in any one or more of a variety of different forms used in the art to alert an operator of the machine 100. For example, the controller 128 may electrically communicate a notification to the interface 130, where the notification can be displayed as a message, a combination of illuminated lighting devices, an audible alert or message, or any other form of notification capable of indicating the location of a discovered air leak to the operator.

### INDUSTRIAL APPLICABILITY

In general, the present disclosure finds utility in various applications, such as on-highway trucks or vehicles, off-highway machines, earth-moving equipment, generators, aerospace applications, pumps, stationary equipment such as power plants, and the like, and more particularly, provides a solution for air leakage problems common to conventional internal combustion engines. Specifically, the present disclosure provides a retrofittable solution that not only detects air leaks within an engine air system, but also locates air leaks within the engine air system based on predefined references or trends in pressure and temperature readings. By monitoring data trends within the engine air system, for instance, the present disclosure is able to identify the location of an air leak without requiring significant downtime and thereby improve overall machine productivity. Also, by relying on sensors that are typically preexisting, the present disclosure provides a simplified solution that reduces implementation costs.

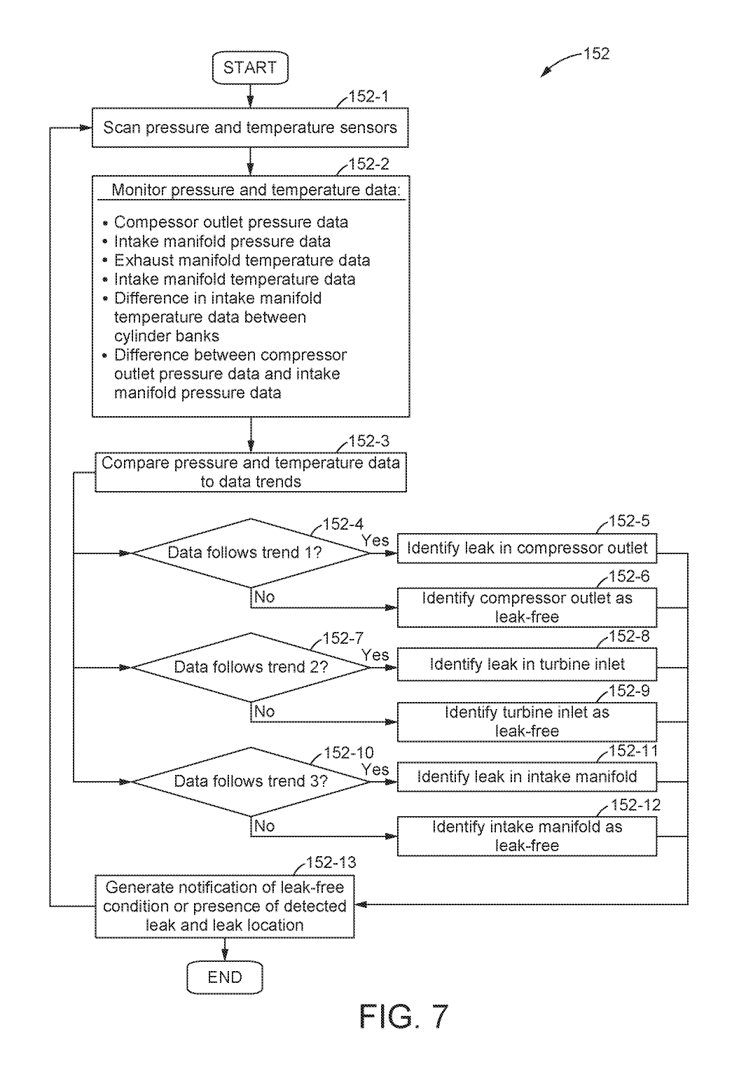

Turning now to FIG. 7, one exemplary algorithm or method 152 of detecting leakage in an engine air system 110 or for controlling the leak detection system 122 is provided. In particular, the method 152 may be implemented in the form of one or more algorithms, instructions, logic operations, or the like, and the individual processes thereof may be performed or initiated via the controller 128. As shown in block 152-1, the method 152 may initially begin scanning or reading the data output by each of the pressure sensors 124 and the temperature sensors 126 associated with the engine air system 110. Correspondingly, in block 152-2, the method 152 may monitor the sensor data for certain traits. For instance, the method 152 may obtain or derive the intake manifold pressure data (P1), the compressor outlet pressure data (P2), the intake manifold temperature data (T1), the exhaust manifold temperature data (T2), the difference in intake manifold temperature data between cylinder banks (T1.1-T1.2 or DT), the difference between compressor outlet pressure data and intake manifold pressure data (P2-P1 or DP), and any other relevant trait.

In addition, the method 152 in block 152-3 of FIG. 7 may compare the obtained, derived and monitored pressure and temperature data to predefined data trends 146, as discussed with respect to FIGS. 4-6 above, to determine whether there is an air leak within the engine air system 110, and if so, to identify the location of the air leak within the engine air system 110. Furthermore, the method 152 may compare the pressure and temperature data to each of the data trends 146 simultaneously, successively or entirely independently of one another. With reference to block 152-4, for example, the method 152 may compare the pressure and temperature data to the first data trend 146-1 of FIG. 4 to determine whether there is an air leak in the outlet of the compressor 118. If any portion or segment of the pressure and temperature data for the given iteration substantially fits or follows the pattern of the first data trend 146-1, the method 152 may identify or confirm that there is a leak and that the leak is located in the outlet of the compressors 118 per block 152-5. If, however, the observed segment of the pressure and temperature data does not substantially follow the first data trend 146-1, the method 152 may confirm or identify the compressors 118 as being leak-free per block 152-6.

Simultaneously or subsequently, the method 152 in block 152-7 of FIG. 7 may compare the pressure and temperature data to the second data trend 146-2 of FIG. 5. If any segment of the pressure and temperature data substantially fits or follows the pattern of the second data trend 146-2, the method 152 may identify or confirm that there is a leak and that the leak is located in the inlet of the turbines 116 per block 152-8. If, however, the observed segment of the pressure and temperature data does not substantially follow the second data trend 146-2, the method 152 may identify the turbines 116 as being leak-free per block 152-9. Similarly, and also simultaneously or subsequently, the method 152 in block 152-10 may further compare the pressure and temperature data to the third data trend 146-3 of FIG. 6. If any segment of the pressure and temperature data for the given iteration substantially follows the pattern of the third data trend 146-3, the method 152 may identify or confirm that there is a leak and that the leak is located in the intake manifolds 134 per block 152-11. If, however, the observed segment of the pressure and temperature data does not substantially follow the third data trend 146-3, the method 152 may identify the intake manifolds 134 as being leak-free per block 152-12.

Once the engine air system 110 has been assessed for leaks, the method 152 in FIG. 7 may proceed to block 152-13 and generate one or more notifications of leak-free conditions and/or the presence of any identified leaks. For instance, the method 152 may generate the notification, such as via the controller 128 and the interface 130 discussed with respect to FIG. 2, and create any combination of audible alerts, visual alerts, haptic alerts, and the like, to appropriately notify operators or other personnel about the leak and enable prompt and appropriate service of the leak. Furthermore, the method 152 may be configured such that the notifications can be communicated locally and/or remotely, such as over wired and/or wireless communication networks. Once areas within the engine air system 110 have been scanned and once any existing air leaks have been identified for the given cycle or iteration, the method 152 may return to block 152-1, or to any of the other preceding blocks, and reiteratively continue scanning for new or additional leaks and/or monitoring previously identified leaks.

Although the method 152 in FIG. 7 illustrates one possible scheme for identifying leaks, other embodiments may refer to fewer than or more than three data trends 146 to detect leaks within the engine air system 110. In other modifications, other combinations of measurements and sensor data, and/or other types of trends or patterns in data may be used to detect and identify leaks located in other parts of the engine air system 110. In still further modifications, each data trend 146 in FIGS. 4-6, or any of the parameters thereof, may be altered to be more or less sensitive to air leaks. Furthermore, leaks within the engine air system 110 may alternatively be detected and located using references other than data trends 146, including, but not limited to, lookup tables, maps, mathematical models, such as models that are completely empirical, completely physics-based, or combinations thereof, and the like. For example, the method 152 may employ a mathematical model of a neural network to receive the sensor data and directly output one of a plurality of predefined status indicators indicative of any leaks within the engine air system 110.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A leak detection system for an engine air system, comprising:
a plurality of pressure sensors configured to retrieve pressure data from the engine air system;
a plurality of temperature sensors configured to retrieve temperature data from the engine air system; and
a controller in communication with each of the pressure sensors and the temperature sensors, the controller being configured to receive the pressure data and the temperature data, compare the pressure data and the temperature data to one or more predefined data trends, and identify a leak within the engine air system based on the comparison.

2. The leak detection system of claim 1, wherein the engine air system includes at least an intake manifold, an exhaust manifold, a turbine and a compressor, the pressure sensors including a first pressure sensor positioned at the compressor and a second pressure sensor positioned at the intake manifold, and the temperature sensors including a first temperature sensor positioned at the exhaust manifold and a second temperature sensor positioned at the intake manifold.

3. The leak detection system of claim 1, wherein the engine air system is configured for two cylinder banks and includes two sets of intake manifolds, exhaust manifolds, turbines and compressors, the pressure sensors for each bank including a first pressure sensor positioned at the compressor and a second pressure sensor positioned at the intake manifold, and the temperature sensors for each bank including a first temperature sensor positioned at the exhaust manifold and a second temperature sensor positioned at the intake manifold.

4. The leak detection system of claim 1, wherein the pressure sensors are configured to retrieve pressure data including compressor outlet pressure data and intake manifold pressure data, and the temperature sensors are configured to retrieve temperature data including exhaust manifold temperature data and intake manifold temperature data.

5. The leak detection system of claim 1, wherein the predefined data trends include a first data trend indicative of a compressor outlet leak, a second data trend indicative of a turbine inlet leak, and a third data trend indicative of an intake manifold leak, the controller being configured to identify the leak as one of the compressor outlet leak, the turbine inlet leak and the intake manifold leak.

6. The leak detection system of claim 1, further comprising a memory for retrievably storing the predefined data trends therein.

7. The leak detection system of claim 1, wherein the controller is further configured to generate a notification if a leak is identified, the notification indicating the presence of the leak and the approximate location of the leak.

8. The leak detection system of claim 7, further comprising an interface configured to communicate the notification to an operator.

9. An air system for an engine, comprising:
an intake manifold having a first pressure sensor and a first temperature sensor;
an exhaust manifold having a second temperature sensor;
a turbine coupled to the exhaust manifold;
a compressor coupled to the intake manifold and having a second pressure sensor; and
a controller coupled to each of the first pressure sensor, the second pressure sensor, the first temperature sensor and the second temperature sensor, the controller being configured to receive pressure data and temperature data, compare the pressure data and the temperature data to one or more predefined data trends, and identify an air leak based on the comparison.

10. The air system of claim 9, wherein the engine includes two cylinder banks, each cylinder bank having an associated arrangement of an intake manifold with a first pressure sensor and a first temperature sensor, an exhaust manifold with a second temperature sensor, a turbine and a compressor with a second pressure sensor.

11. The air system of claim 9, wherein the first pressure sensor is configured to retrieve compressor outlet pressure data, the second pressure sensor is configured to retrieve intake manifold pressure data, the first temperature sensor is configured to retrieve exhaust manifold temperature data, and the second temperature sensor is configured to retrieve intake manifold temperature data.

12. The air system of claim 9, wherein the predefined data trends include a first data trend indicative of a compressor outlet leak, a second data trend indicative of a turbine inlet leak, and a third data trend indicative of an intake manifold leak.

13. The air system of claim 9, further comprising a memory for retrievably storing the predefined data trends therein.

14. The air system of claim 9, wherein the controller is configured to identify the leak as one of an intake manifold leak, a turbine inlet leak and a compressor outlet leak.

15. The air system of claim 9, wherein the controller is further configured to generate a notification if a leak is identified, the notification indicating the presence of the leak and the approximate location of the leak.

16. The air system of claim 9, further comprising an aftercooler coupled in between the compressor and the intake manifold.

17. A method of detecting leakage in an engine air system, comprising:
receiving pressure data including compressor outlet pressure data and intake manifold pressure data, and temperature data including exhaust manifold temperature data and intake manifold temperature data;
comparing the pressure data and the temperature data to one or more predefined data trends; and
identifying a leak within the engine air system based on the comparison.

18. The method of claim 17, wherein the compressor outlet pressure data is received from a first pressure sensor positioned at a compressor, the intake manifold pressure data is received from a second pressure sensor positioned at an intake manifold, the exhaust manifold temperature data is received from a first temperature sensor positioned at an exhaust manifold, and the intake manifold temperature data is received from a second temperature sensor positioned at the intake manifold.

19. The method of claim 17, wherein the predefined data trends include a first data trend indicative of a compressor outlet leak, a second data trend indicative of a turbine inlet leak, and a third data trend indicative of an intake manifold leak, the leak being identified as one of the intake manifold leak, the turbine inlet leak and the compressor outlet leak.

20. The method of claim 17, further comprising:
generating a notification if a leak is identified, the notification indicating the presence of the leak and the approximate location of the leak.
